(19) United States
(12) Patent Application Publication
(10) Pub. No.: US 2025/0388015 A1
(43) Pub. Date: Dec. 25, 2025

(54) LIQUID EJECTION HEAD AND METHOD FOR MANUFACTURING LIQUID EJECTION HEAD

(71) Applicant: CANON KABUSHIKI KAISHA, Tokyo (JP)

(72) Inventors: HIROAKI MIHARA, Tokyo (JP); TOMOHIRO TAKAHASHI, Kanagawa (JP); HIROYUKI YAMAMOTO, Kanagawa (JP)

(21) Appl. No.: 19/235,917

(22) Filed: Jun. 12, 2025

(30) Foreign Application Priority Data
Jun. 19, 2024 (JP) 2024-098641

(51) Int. Cl. B41J 2/14; B41J 2/16

(52) U.S. Cl. CPC B41J 2/1433; B41J 2/162; B41J 2/1631; B41J 2002/14491

(57) ABSTRACT

An object of the technique of the present disclosure is to provide a liquid ejection head having high reliability in which breakage of a nozzle is less likely to occur. A liquid ejection head comprises: a nozzle forming member in which a nozzle configured to eject a liquid is formed; a substrate being stacked on the nozzle forming member and including a flow passage for supplying the liquid to the nozzle; and a protrusion protruding more than a surface of the nozzle forming member, and having a base end in contact with the substrate, in a direction perpendicular to the surface of the nozzle forming member.

### BACKGROUND

### Field of the Technology

The present disclosure relates to a liquid ejection head and a method for manufacturing a liquid ejection head.

### Description of the Related Art

In some liquid ejection heads which conduct printing by ejecting a liquid from nozzles onto a printing medium, a step is formed near the nozzles for protecting the nozzles from abutment from an outside.

Japanese Patent Laid-Open No. 2009-208349 discloses a liquid ejection head in which part of a liquid repellent film formed on an ejection surface (an ejection port surface) of a nozzle plate (a nozzle forming member) is removed and a protrusion (a step) is formed in the removed portion.

However, for the conventional protrusion, there is a case where the protrusion is peeled off if a strong impact is applied to the protrusion for some reason.

### SUMMARY

In view of this, an object of the present disclosure is to provide a liquid ejection head having high reliability in which breakage of a nozzle is less likely to occur.

A liquid ejection head according to the present disclosure includes: a nozzle forming member in which a nozzle configured to eject a liquid is formed; a substrate being stacked on the nozzle forming member and including a flow passage for supplying the liquid to the nozzle; and a protrusion protruding more than a surface of the nozzle forming member, and having a base end buried inside the nozzle forming member, in a direction perpendicular to the surface of the nozzle forming member.

Features of the present disclosure will become apparent from the following description of embodiments with reference to the attached drawings. The following description of embodiments are described by way of example.

### BRIEF DESCRIPTION OF THE DRAWINGS

FIG. 1 is a perspective view of a liquid ejection head in one embodiment as viewed from a bottom rear side;

FIG. 2 is a schematic partial sectional view of a printing element board in the one embodiment;

FIG. 3 is a schematic bottom view of the printing element board;

FIG. 4A is a schematic view showing a state of cleaning nozzles by using a blade of the one embodiment;

FIG. 4B is a schematic sectional view showing how a foreign substance is appropriately removed;

FIG. 4C is a schematic sectional view showing a reference example in the removal of the foreign substance;

FIG. 5 is a flowchart showing one example of a method for manufacturing a printing element board;

FIG. 6A is an explanatory view of S501;

FIG. 6B is an explanatory view of S504;

FIG. 6C is an explanatory view of S507;

FIG. 6D is an explanatory view of S508;

FIG. 6E is an explanatory view of S510;

FIG. 7A is a diagram showing one modification in the liquid ejection head of the one embodiment;

FIG. 7B is a diagram showing one modification in the liquid ejection head of the one embodiment;

FIG. 7C is a diagram showing one modification in the liquid ejection head of the one embodiment;

FIG. 7D is a diagram showing one modification in the liquid ejection head of the one embodiment;

FIG. 7E is a diagram showing one modification in the liquid ejection head of the one embodiment;

FIG. 8 is a diagram showing one modification of the liquid ejection head;

FIG. 9 is a flowchart showing an example of a method for manufacturing a printing element board;

FIG. 10 is an explanatory view of one step of the method for manufacturing a printing element board;

FIG. 11 is a schematic sectional view of the printing element board in one embodiment;

FIG. 12 is an explanatory view of one modification of the step of the method for manufacturing a printing element board;

FIG. 13 is an explanatory view of one step of the method for manufacturing a printing element board;

FIG. 14A is an explanatory view of a step of applying a third resin in one embodiment; and

FIG. 14B is an explanatory view of an effect of grooves.

### DESCRIPTION OF THE EMBODIMENTS

### First Embodiment

### <Liquid Ejection Head 100>

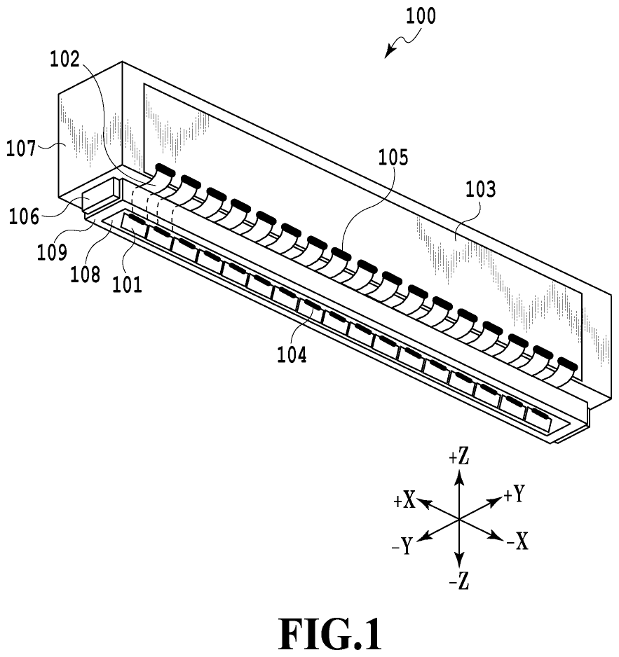

FIG. 1 is a perspective view of a liquid ejection head 100 which is applicable to the present embodiment as viewed from a bottom rear side.

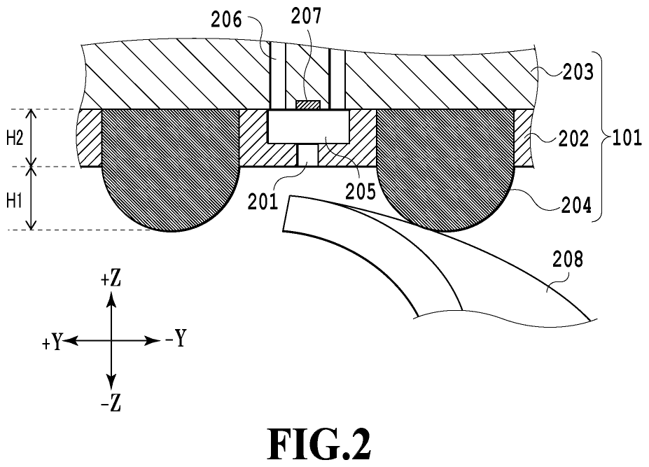

Coordinate axes in the drawings will be described. A±X direction indicates a longitudinal direction of the liquid ejection head 100, that is, a direction in which a plurality of nozzles are arrayed. A±Y direction is a direction orthogonal to the ±X direction, and indicates a depth direction of the liquid ejection head 100. The −Y direction corresponds to a conveyance direction of a printing medium 208 (see FIG. 2 and the like). The −Y direction is called the conveyance direction as appropriate. A±Z direction is a direction orthogonal to the ±X direction and the ±Y direction. The Z direction indicates a height direction of the liquid ejection head 100. The −Z direction corresponds to a direction in which a liquid is ejected from the liquid ejection head 100.

The present embodiment will be described on the assumption that the “liquid” is an ink. However, the liquid which can be used in the present embodiment is not limited to an ink. That is, as the liquid, various printing liquids including treatment liquids and the like which are used for the purpose of improving the fixability of an ink on a printing medium, reducing gloss unevenness, or improving scratch resistance.

“Printing” does not mean only forming significant information such as a character and a figure. “Printing” also means forming insignificant information such as an image, design, or pattern. Moreover it does not matter whether or not “printing” is so visualized that it can be visually perceived by humans. That is, “printing” also means forming a structure on a printing medium or processing a medium.

As shown in FIG. 1, the liquid ejection head 100 includes a printing element board 101 capable of ejecting a liquid (for example, an ink).

In the present embodiment, the liquid ejection head 100 is capable of conducting full-color printing using inks of cyan, magenta, yellow, and black. Note that printing using an ink other than these four colors may be conducted. For example, black-and-white printing using an ink of black may be conducted.

In the present embodiment, a plurality of printing element boards 101 are arranged in straight line (in line) in the X direction. Each printing element board 101 is electrically connected an electric wiring board 103 via a flexible printed circuit board 102. The electric wiring board 103 includes signal input terminals (not shown) and power supply terminals (not shown).

The signal input terminals and the power supply terminals are electrically connected to a control unit (for example, a CPU which is not shown) of a liquid ejection apparatus in a state where the liquid ejection head 100 is mounted on a main body (not shown) of the liquid ejection apparatus. The signal input terminals and the power supply terminals supply ejection drive signals and power required for ejection to the printing element board 101, respectively.

The numbers of the signal input terminals and the power supply terminals can be made smaller than the number of the printing element boards 101 by consolidating wires by using an electric circuit provided inside the electric wiring board 103. According to this configuration, the number of electric connection portions that need to be removed at the time of mounting the liquid ejection head 100 on a liquid ejection apparatus or at the time of replacing the liquid ejection head 100 can be reduced.

In addition, the electric connection portions between the printing element board 101 and the flexible printed circuit board 102 are sealed by a first sealant 104. On the other hand, the electric connection portions between the flexible printed circuit board 102 and the electric wiring board 103 are sealed by a second sealant 105. The printing element board 101 is fixed to a base 106 inside of which flow passages for passing the ink are formed, with an adhesive (not shown). Note that there a plurality of bonding portions of the printing element boards 101 and the base 106.

The ink is supplied to the base 106 through a case 107. The base 106 and the flexible printed circuit boards 102 are covered by a cover 109 which has an opening portion 108. The printing element boards 101 are exposed through the opening portion 108 of the cover 109. Edges of the opening portion 108 are sealed by a curable liquid material to be a substantially flat surface.

FIG. 2 is a schematic partial sectional view of the printing element board 101 which is applicable to the present embodiment.

As shown in FIG. 2, the printing element board 101 includes: a nozzle forming member 202 in which a nozzle 201 configured to eject the liquid is formed; a substrate 203 which is formed of silicon; and protrusions 204 which protrude from a lower surface of the substrate 203 more than a lower surface of the nozzle forming member 202.

Parts of the protrusions 204 are buried in the nozzle forming member 202. In the present embodiment, a depth by which base end portions of the protrusions 204 are buried in the nozzle forming member 202 (a length in the Z direction of FIG. 2) is substantially equal to a thickness of the nozzle forming member 202 (a length in the Z direction of FIG. 2).

In the nozzle forming member 202, a pressure chamber 205 configured to receive pressure at the time of ejecting the liquid from the nozzle 201 is formed. The nozzle 201 is formed to be connected to the pressure chamber 205. On an upper surface of the nozzle forming member 202, the substrate 203 is stacked. In the substrate 203, flow passages 206 for supplying the liquid to the pressure chamber 205 of the nozzle forming member 202 are formed, and a heater 207 which is a heating resistance element is provided.

In a state where a lower surface of the substrate 203 is bonded to the upper surface of the nozzle forming member 202, the heater 207 is provided at a position facing the nozzle 201, and the flow passages 206 are connected to the pressure chamber 205. To the heater 207, pulse signals having a constant power are supplied through an electric wire, which is not shown.

In the present embodiment, the power is supplied to the heater 207 with very short pulses. For example, the power is supplied to the heater 207 at a pulse width of about 0.1 μsec to 10.0 μsec. By supplying the power to the heater 207 in this way, film-boiling is generated in the liquid with which the inside of the pressure chamber 205 is filled. Then, the liquid is ejected from the nozzle 201 by the bubble-generating energy.

Meanwhile, in a case where the printing medium 208 is conveyed in a state of being deformed for some reason, there is a possibility that the printing medium 208 comes into contact with the nozzle 201, so that the nozzle 201 is ground. For example, if paper jamming occurs under a circumstance where glossy paper containing an inorganic particle component having a relatively high rigidity is used as the printing medium 208, there is a case where the nozzle 201 is ground by the glossy paper deformed by the paper jamming.

In view of this, in the present embodiment, the protrusions 204 are provided near the nozzle 201 in order to prevent the nozzle 201 from being ground by the printing medium 208. According to this configuration, even if the deformed printing medium 208 is coming toward the nozzle 201, since the protrusions 204, which protrude, come into contact with the deformed printing medium 208 and push back the deformed printing medium 208, it is possible to prevent the nozzle 201 from being damaged.

However, in the configuration of Japanese Patent Laid-Open No. 2009-208349, since protruding structures (protrusions) are bonded to a lower surface of a nozzle forming member 202, if glossy paper comes into contact with the protruding structures with relatively strong force, there is a possibility that the protruding structures are peeled off.

In contrast, in the present embodiment, the upper surfaces of the protrusions 204 are bonded to the lower surface of the substrate 203, the base end portions of the protrusions 204 are buried in the nozzle forming member 202, and leading end portions of the protrusions 204 protrude downward more than the lower surface of the nozzle forming member 202. That is, the protrusions 204 of the present embodiment are supported by the nozzle forming member 202 from the side surfaces.

Note that “H2” in FIG. 2 indicates the height of the base end portions of the protrusions 204. “H1” in FIG. 2 indicates the height of the leading end portions of the protrusions 204. The height of the base end portions of the protrusions 204 is equal to the thickness of the nozzle forming member 202. According to this configuration, since the base end portions of the protrusions 204 are buried in the nozzle forming member 202, the protrusion 204 can withstand an impact generated in a case where the printing medium 208 comes into contact with the protrusion 204 more than the configuration of Japanese Patent Laid-Open No. 2009-208349. Hence, as compared with the configuration of Japanese Patent Laid-Open No. 2009-208349, even in a case where glossy paper has come into contact with the protrusion 204, it is possible to reduce a possibility that the protrusion 204 is peeled off.

Note that it is preferable that the protrusion 204, the first sealant 104 (see FIG. 1), and the second sealant 105 (see FIG. 1) be formed of the same material (for example, epoxy resin having a thermosetting property). According to this configuration, it is possible to unify the material, and to thus reduce time and effort as compared with a case of forming theses members by using different materials.

In addition, it is preferable that the elastic modulus of the protrusions 204 be 2 GPa (gigapascal) or more. According to this configuration, the protrusion 204 can withstand an impact generated in a case where the printing medium 208 comes into contact with the protrusion 204. It is further preferable that the elastic modulus of the protrusions 204 be 4 GPa or more. According to this configuration, the protrusion 204 can further withstand an impact generated in a case where the printing medium 208 comes into contact with the protrusion 204 with a margin.

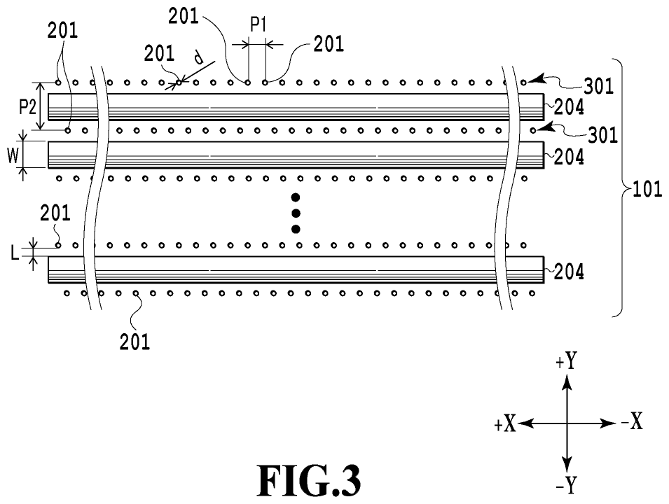

FIG. 3 is a schematic bottom view of the printing element board 101.

In FIG. 3, the printing medium 208 (see FIG. 2) is conveyed in the −Y direction. For this reason, by providing the protrusions 204 in such a manner as to extend in a direction (the ±X direction) in which the nozzles 201 are arrayed, which is orthogonal to the conveyance direction, the plurality of nozzles 201 can be protected.

In the present embodiment, the protrusion 204 is arranged in parallel with one nozzle array 301 which is formed by arranging a plurality of nozzles 201 in the X direction. Note that in the present embodiment, a plurality of nozzle arrays 301 are arranged in the conveyance direction (the Y direction), and one protrusion 204 is provided between adjacent two nozzle arrays 301.

Hereinafter, an example of dimensions of a configuration which is applicable to the present embodiment will be described. A pitch “P1” between two nozzles may be in a range of 20 to 500 μm. The diameter “d” of the nozzle 201 may be in a range of 5 to 100 μm. The distance “L” from an end portion of the nozzle 201 to the protrusion 204 in the Y direction may be more than 20 μm and less than 500 μm. It is further preferable that the distance “L” be 50 μm or more and 200 μm or less. As the distance “L” is shorter, the guarding capability of protecting the nozzles 201 becomes higher.

However, on the other hand, when a material constituting the protrusions 204 is applied, there is a possibility that that material attaches to the nozzles 201. In view of this, by setting the distance “L” to 50 μm or more, when the material constituting the protrusions 204 is applied, the possibility that that material attaches to the nozzles 201 can be almost eliminated.

In addition, in the case where the distance “L” is 500 μm or more, the effect of protecting the nozzles 201 is almost lost. In the case where the distance “L” is 200 μm or less, the effect of protecting the nozzles 201 becomes very large.

In addition, a pitch “P2” in FIG. 3 indicates a pitch between two nozzle arrays in the Y direction. The width “W” of the protrusions 204 is naturally determined as the pitch “P2” and the distance “L” are determined. For example, the width “W” of the protrusions 204 can be obtained in accordance with the following formula (1).

W=the pitch “P2”−(the distance “L”×2) (formula 1)

The pitch “P2” varies depending on the internal structure of the printing element board 101 and the conditions for image formation. The pitch “P2” may be 200 μm or more and 2000 μm or less.

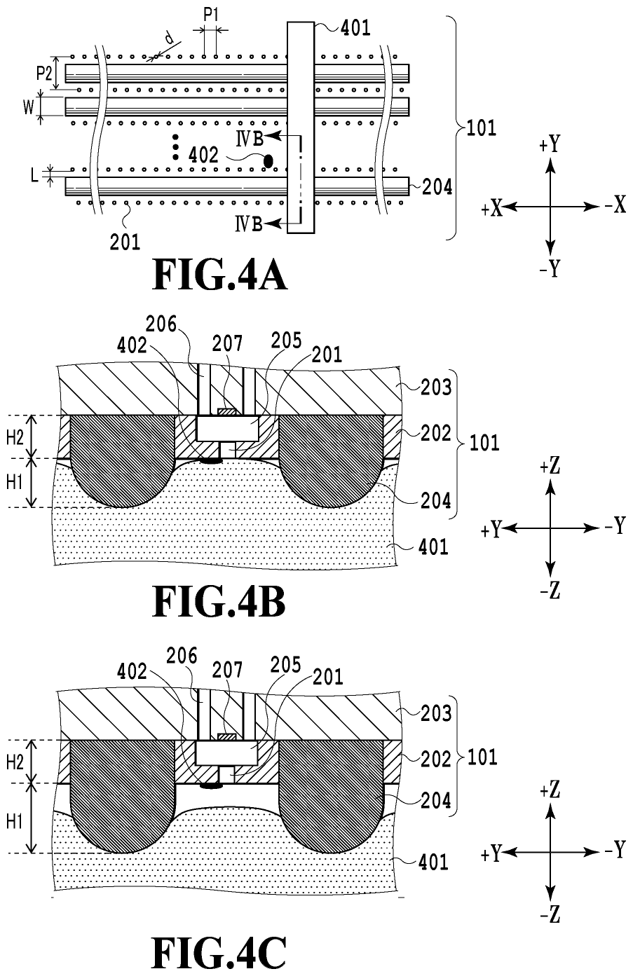

FIG. 4A is a schematic view showing a state of cleaning the nozzles 201 by using a blade 401 which is applicable to the present embodiment.

As shown in FIG. 4A, the blade 401 is configured to be capable of removing a foreign substance 402 (for example, the ink that has adhered to the nozzle surface) while moving along a blade traveling direction (the X direction). Note that in the present embodiment, it is possible to clean a plurality of nozzle arrays 301 together by using one blade 401.

FIG. 4B is a schematic sectional view showing how the foreign substance 402 is appropriately removed.

As shown in FIG. 4B, in the case where the height “H1” of the protrusions 204 is an appropriate dimension, the foreign substance 402 that has adhered near the nozzle 201 can be removed by using the blade 401. The height “H1” of the protrusions 204 may be 10 μm or more and 100 μm or less. It is further preferable that the height “H1” of the protrusion 204 be more than 20 μm and less than 60 μm.

It is assumed that the distance “L” is more than 20 μm and less than 500 μm, and the width “W” of the protrusions 204 is in a dimensional range that can be obtained in accordance with the above-described (formula 1). In this case, if the height “H1” is 60 μm or more, there is a tendency that the blade 401 gradually becomes less likely to reach the nozzle surface, and the cleaning capability for the nozzles 201 decreases. In the case where the height “H1” is 20 μm or less, the effect of protecting the nozzles 201 decreases. It is preferable that the height “H2” be 3 μm or more.

In the case where the base end portions of the protrusions 204 are buried in the nozzle forming member 202 by 3 μm or more, the fixation of the protrusions 204 is reinforced as compared with the configuration in which the protrusions 204 are not buried in the nozzle forming member 202. It is further preferable that the height “H2” be 5 μm or more. In the case where parts of the protrusion 204 are buried in the nozzle forming member 202 by 5 μm or more, the fixation of the protrusions 204 is further reinforced as compared with the configuration in which the protrusions 204 are buried in the nozzle forming member 202 by 3 μm.

FIG. 4C is a schematic sectional view showing a reference example in the removal of the foreign substance 402.

As shown in FIG. 4C, from the viewpoint of protecting the nozzles 201, it is preferable that the height “H1” of the protrusions 204 be higher. However, if the dimension of the height “H1” of the protrusions 204 is too large, the blade 401 does not reach the nozzle surface and it becomes difficult to remove the foreign substances 402. For this reason, it is preferable that the height “H1” of the protrusions 204 be configured to be in the aforementioned dimension.

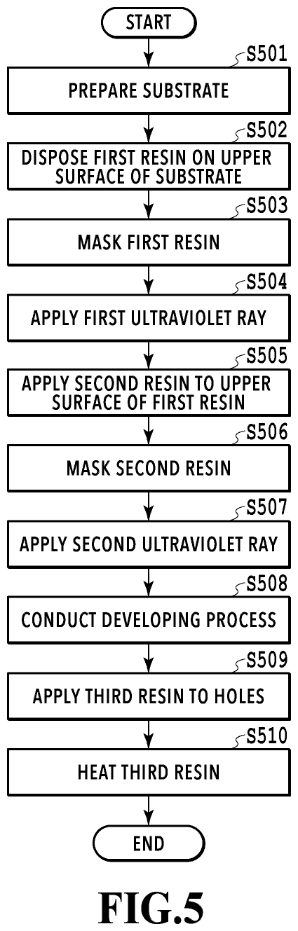

FIG. 5 is a flowchart showing a method for manufacturing the printing element board 101 which is applicable to the present embodiment. In FIG. 5, sign “S” means step.

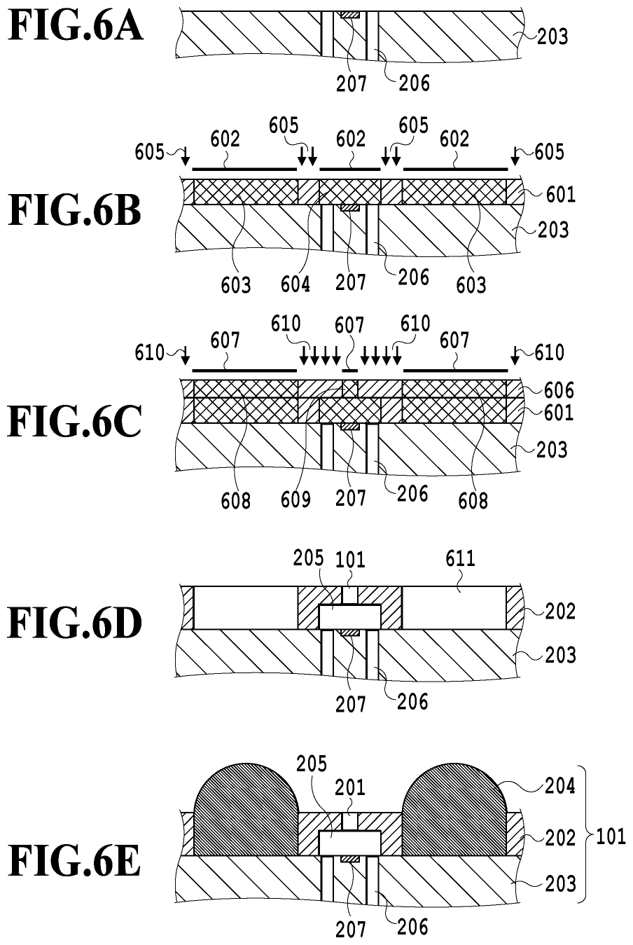

FIG. 6A to FIG. 6D are explanatory views for explaining the respective steps of the method for manufacturing the printing element board 101 which is applicable to the present embodiment. Hereinafter, the steps for manufacturing the printing element board 101 will be described in accordance with FIG. 5 while referring to FIG. 6A to FIG. 6D.

In S501, a substrate 203 including flow passages 206 and heaters 207 is prepared.

FIG. 6A is an explanatory view of S501. Hereinafter, the description is made while a surface facing upward in FIG. 6A is called an upper surface for convenience of the description.

As shown in FIG. 6A, in S501, a substrate 203 including flow passages 206 and heaters 207 is prepared. Pluralities of the flow passages 206 and heaters 207 are arrayed in a direction perpendicular to the sheet surface.

In the substrate 203, wiring (not shown) is provided so that the heaters 207 can conduct desired drive, and the flow passages 206 are formed. An example of the method for forming wiring including the heaters 207 is a photolithography technique for forming a semiconductor element. An example of the method for forming the flow passages 206 is a dry etching. Another example of the method for forming the flow passages 206 is wet etching, sandblast, or the like. The description will be continued below with reference to FIG. 5 again. After S501, S502 is conducted.

In S502, a first resin 601 which is made into a dry film is disposed on the upper surface of the substrate 203. The first resin 601 is a negative ultraviolet curable resin. It is preferable that an epoxy resin be used as the first resin 601 from the viewpoint of ink resistance. Note that in the present embodiment, a cationic polymerized epoxy resin is used as the first resin 601.

The thickness of the first resin 601 (see FIG. 6B) disposed on the upper surface of the substrate 203 is equal to the height of the pressure chamber 205 (see FIG. 2 and the like) in the nozzle forming member 202 (see FIG. 2 and the like). In the present embodiment, the nozzle forming member 202 includes a layer for forming the pressure chambers 205 and a layer for forming the nozzles 201 (see FIG. 2 and the like). By curing the first resin 601, the layer for forming the pressure chambers 205 in the nozzle forming member 202 is formed.

In S503, the first resin 601 is masked by using a first mask 602 (see FIG. 6B). First planned portions 603 (see FIG. 6B) for forming holes 611 (see FIG. 6D) for applying a third resin constituting the protrusions 204 (see FIG. 2 and the like) are masked by the first mask 602. Second planned portions 604 (see FIG. 6B) for forming the pressure chambers 205 (see FIG. 2 and the like) are also masked by the first mask 602. The description will be continued below with reference to FIG. 5 again. After S503, S504 is conducted.

In S504, a first ultraviolet ray 605 (see FIG. 6B) is applied toward the upper surface of the first resin 601 to cure the first resin 601.

FIG. 6B is an explanatory view of S504. Hereinafter, the description is made while a surface facing upward in FIG. 6B is called an upper surface for convenience of the description.

As shown in FIG. 6B, in S504, the first ultraviolet ray 605 is applied toward the upper surface of the first resin 601 over the first mask 602. In this way, portions of the first resin 601 which are not masked are cured. The description will be continued below with reference to FIG. 5 again. After S504, S505 is conducted.

In S505, the above-mentioned second resin 606 (see FIG. 6C) is applied to the upper surface of the first resin 601 (see FIG. 6C) by spin coating. The second resin 606 is also a negative ultraviolet curable resin like the first resin 601. By curing the second resin 606, a layer for forming the nozzles 201 (see FIG. 2 and the like) is formed among two layers constituting the nozzle forming member 202. The description will be continued below with reference to FIG. 5 again. After S505, S506 is conducted.

In S506, the second resin 606 is masked by using a second mask 607 (see FIG. 6C). Third planned portions 608 (see FIG. 6C) for forming the holes 611 for applying the above-mentioned third resin and fourth planned portions 609 (see FIG. 6B) for forming the nozzles 201 (see FIG. 2 and the like) are masked by the second mask 607. The description will be continued below with reference to FIG. 5 again. After S506, S507 is conducted.

In S507, a second ultraviolet ray 610 (see FIG. 6C) is applied toward the upper surface of the second resin 606 to cure the second resin 606.

FIG. 6C is an explanatory view of S507.

As shown in FIG. 6C, in S507, the second ultraviolet ray 610 is applied toward the upper surface of the second resin 606 over the second mask 607. In this way, portions of the second resin 606 which are not masked are cured. The description will be continued below with reference to FIG. 5 again. After S507, S508 is conducted.

In S508, a developing process is conducted on the first resin 601 and the second resin 606 to form the nozzle forming member 202.

FIG. 6D is an explanatory view of S508.

As shown in FIG. 6D, the nozzle forming member 202 includes the holes 611 for applying the third resin constituting the pressure chambers 205, the nozzles 201, and the protrusions 204 (see FIG. 2 and the like). By the developing process, the first planned portions 603 (see FIG. 6B) and the second planned portions 604 (see FIG. 6B) are washed down in the first resin 601. Then, the third planned portions 608 (see FIG. 6C) and the fourth planned portions 609 (see FIG. 6C) are washed down in the second resin 606.

By washing down the uncured portions of the first resin 601 and the second resin 606 in this way, the pressure chambers 205 and the nozzles 201 are formed in the second planned portions 604 and the fourth planned portions 609. Then, by washing down the first planned portions 603 and the third planned portions 608, the holes 611 are formed. That is, in S508, by conducting the developing process on the first resin 601 and the second resin 606, the pressure chambers 205, the nozzles 201, and the holes 611 of the nozzle forming member 202 are simultaneously formed. The description will be continued below with reference to FIG. 5 again. After S508, S509 is conducted.

In S509, a third resin which is a liquid having a thermosetting property is applied to the insides of the holes 611 (see FIG. 6D). In S509, the third resin is applied in such a manner as to have a desired height. It is preferable that the third resin be an epoxy resin from the viewpoint of ink resistance. In S509, the third resin may be applied by using a dispenser, or the third resin may be applied by screen printing, jet dispensing, or the like.

It is preferable that the viscosity of the third resin at the time of application be 50 Pa·s (pascal·second) or more and 1000 Pa·s or less. If the viscosity of the third resin is in this range, it is possible to form protruding shapes which protrude to a desired height outward from the nozzle surface.

In addition, it is further preferable that the viscosity of the third resin at the time of application be 100 Pa·s or more and 500 Pa·s or less. If the viscosity of the third resin in this range, it becomes easier to mold the third resin into protruding shapes. The description will be continued below with reference to FIG. 5 again. After S509, S510 is conducted.

In S510, the third resin is heated. As described above, the third resin has a thermosetting property. For this reason, by heating the third resin, the third resin is cured. By curing the third resin, the protrusions 204 are completed.

FIG. 6E is an explanatory view of S510.

As shown in FIG. 6E, the substrate 203, the nozzle forming member 202, and the protrusions 204 are separate members from one another. For this reason, in a state where the cross section of the printing element board 101 is viewed, it can be seen that the bottom surfaces of the protrusions 204 are fixed to the upper surface of the substrate 203.

In addition, boundary lines appear between the nozzle forming member 202 and the protrusions 204. For this reason, even in a case where the color of the nozzle forming member 202 and the color of the protrusions 204 are the same, it can be seen that the base end portions of the protrusions 204 are buried in the holes 611 (see FIG. 6D) of the nozzle forming member 202 by viewing the cross section of the printing element board 101.

As described above, in the liquid ejection head of the present embodiment, the base end portions of the protrusions are formed to be buried in the nozzle forming member.

According to this configuration, the lower surfaces (surfaces facing downward in FIG. 6E) of the protrusions are fixed as compared with the configuration in which the protrusions are fixed to the ejection port surface (that is, the surface of the nozzle forming member 202). Moreover, parts of the outer peripheral surfaces of the protrusions are fixed to the inner peripheral surfaces of the holes formed in the nozzle forming member. For this reason, portions to fix the protrusion can be increased as compared with the configuration in which the protrusions are fixed to the ejection port surface. Hence, even in the case where a printing medium or the like has collided with the protrusion, the protrusions are more likely to withstand the impact.

Therefore, according to the technique of the present embodiment, a liquid ejection head having high reliability can be provided.

In the liquid ejection head of Japanese Patent Laid-Open No. 2009-208349, protrusions are formed in removed portions obtained by removing a liquid repellent film. In other words, in the liquid ejection head of Japanese Patent Laid-Open No. 2009-208349, a liquid repellent film is once formed, and it is difficult to form the protrusions without specifying regions where the protrusions are to be formed by removing parts of the liquid repellent film. In the present embodiment, regardless of the presence or absence of a liquid repellent film, the protrusions can be formed, and the degree of freedom in forming the protrusions is increased as compared with the liquid ejection head of Japanese Patent Laid-Open No. 2009-208349.

In addition, even in the case of forming a liquid repellent film, since it is unnecessary to remove the liquid repellent film once formed for specifying regions where the protrusions are to be formed, the manufacturing method of the present embodiment is less wasteful than the manufacturing method of Japanese Patent Laid-Open No. 2009-208349. Hence, according to the technique of the present embodiment, even in the case of forming a liquid repellent film, a liquid ejection head having high reliability can be provided without wasting the liquid repellent film.

### [Modifications of First Embodiment]

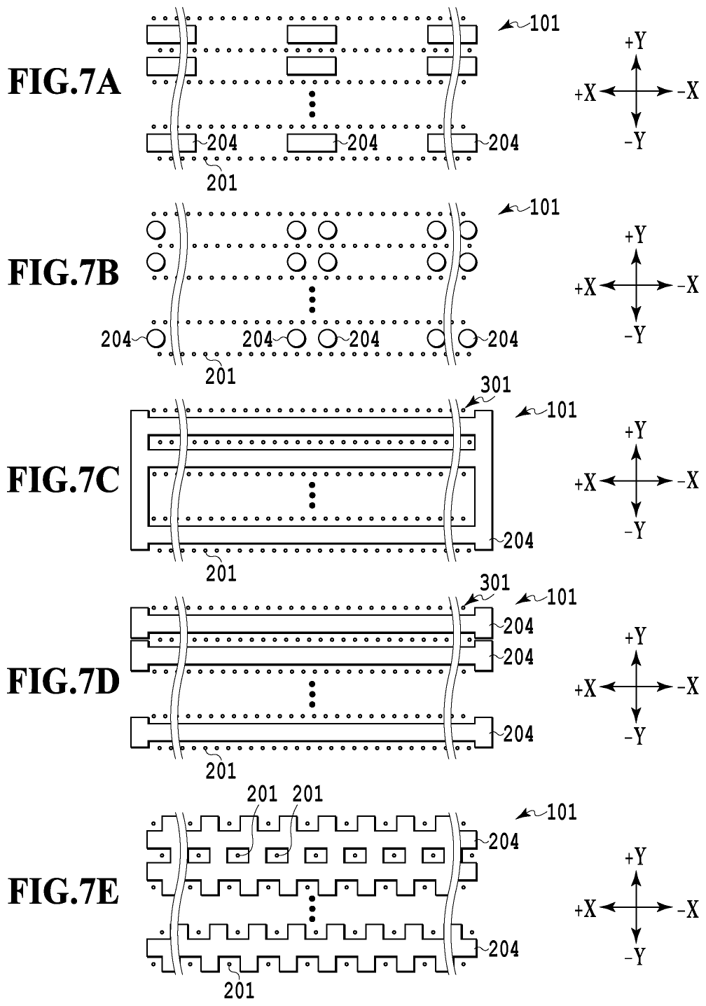

FIG. 7A to FIG. 7E are diagrams showing modifications of the liquid ejection head of the first embodiment.

FIG. 7A is a diagram showing a first modification in the liquid ejection head of the first embodiment.

As shown in FIG. 7A, a plurality of protrusions 204 may be formed in the form of dashed lines in a direction intersecting the conveyance direction in a state where the printing element board 101 is viewed in plan view. With such a configuration as well, a liquid ejection head having high reliability can be provided. According to this configuration, the application amount of the third resin constituting the protrusions 204 can be reduced, and the cost can be reduced, as compared with the example of FIG. 3.

FIG. 7B is a diagram showing a second modification in the liquid ejection head of the first embodiment.

As shown in FIG. 7B, a plurality of protrusions 204 may be scattered in the form of dots in a direction intersecting the conveyance direction in a state where the printing element board 101 is viewed in plan view. With such a configuration as well, a liquid ejection head having high reliability can be provided. According to this configuration, the application amount of the third resin constituting the protrusions 204 can be reduced, and the cost can be further reduced, as compared with the first modification.

FIG. 7C is a diagram showing a third modification in the liquid ejection head of the first embodiment.

As shown in FIG. 7C, protrusions 204 each having a portion which extends in the conveyance direction in such a manner as to connect portions which extend in a direction intersecting the conveyance direction outward of end portions of the nozzle arrays 301 in a state where the printing element board 101 is viewed in plan view may be formed. According to this configuration, the nozzles 201 located on both end portions of the nozzle array can be more easily protected, and a liquid ejection head having higher reliability can be provided, as compared with the example of FIG. 3.

FIG. 7D is a diagram showing a fourth modification in the liquid ejection head of the first embodiment.

As shown in FIG. 7D, protrusions 204 each having a portion which extends in the conveyance direction in such a manner as not to connect portions which extend in a direction intersecting the conveyance direction outward of end portions of the nozzle arrays 301 in a state where the printing element board 101 is viewed in plan view may be formed. According to this configuration, the application amount of the third resin constituting the protrusions 204 can be reduced, and the cost can be reduced, as compared with the third modification.

FIG. 7E is a diagram showing a fifth modification in the liquid ejection head of the first embodiment.

As shown in FIG. 7E, in the case where the pitch between two nozzles is relatively large, protrusions 204 in a lattice shape surrounding one nozzle 201 in a state where the printing element board 101 is viewed in plan view may be formed. In this way, in the case where the pitch between two nozzles is relatively large, or the like, protrusions 204 each of which not only extends in parallel with the nozzle array 301 but also extends between two nozzles may be formed. According to this configuration, the protection capability for the nozzles 201 can be further improved by forming the protrusion 204 between two nozzles, as compared with the example of FIG. 3.

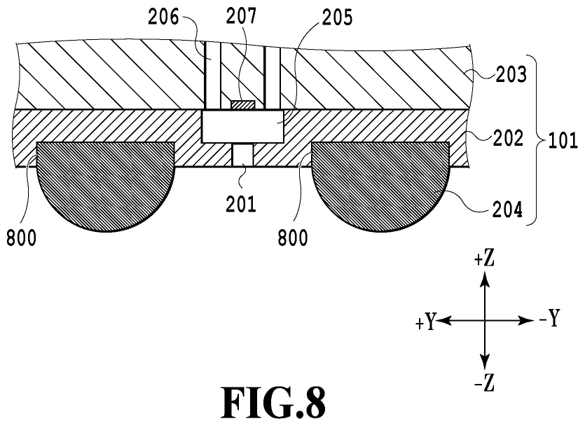

FIG. 8 is a diagram showing a sixth modification in the liquid ejection head of the first embodiment.

In the example of FIG. 6D, the holes 611 which penetrate the nozzle forming member 202 in the Z direction in the posture for manufacturing the printing element board 101 are formed in the nozzle forming member 202 in order to apply the third resin. However, regions for applying the third resin are not limited to the holes 611 which penetrate the nozzle forming member 202.

In the example shown in FIG. 8, a depth by which the protrusions 204 are buried in the nozzle forming member 202 (a length thereof extending in the Z direction of FIG. 8) is substantially equal to a length of the nozzles 201 (a length thereof extending in the Z direction of FIG. 8).

In this way, recess portions 800 having a length substantially equal to the length of nozzles 201 may be formed in the second resin 606 constituting the nozzle forming member 202 in order to apply the third resin constituting the protrusion 204. In addition, regardless of the length of the nozzles 201, recess portions 800 having a distance shorter than the thickness of the nozzle forming member 202 may be formed. That is, regions for applying the third resin only have to be holes having recesses, and do not have to be through-holes. Then, the protrusions 204 may be formed by applying the third resin to the recess portions 800. With such a configuration as well, a liquid ejection head having high reliability can be provided.

### Second Embodiment

An object of the present embodiment is to provide a liquid ejection head which can further improve the protection capability for nozzles. In the following description, configurations that are the same as or correspond to those in the first embodiment are denoted by the same signs and description thereof is omitted, and different points will be mainly described.

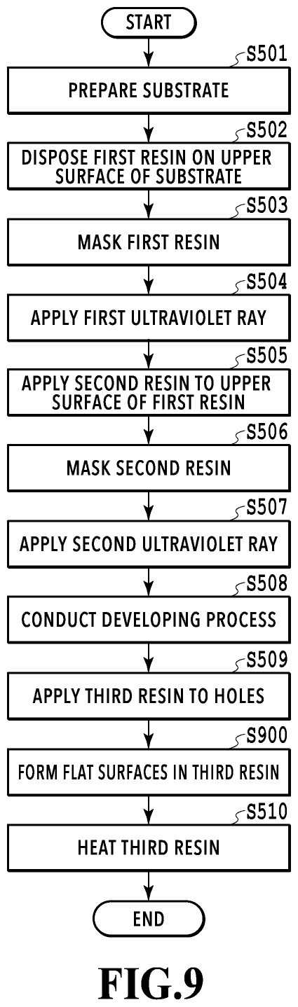

FIG. 9 is a flowchart showing a method for manufacturing a printing element board 101 which is applicable to the present embodiment.

As shown in FIG. 9, in the present embodiment, S900 is conducted after S509 and before S510.

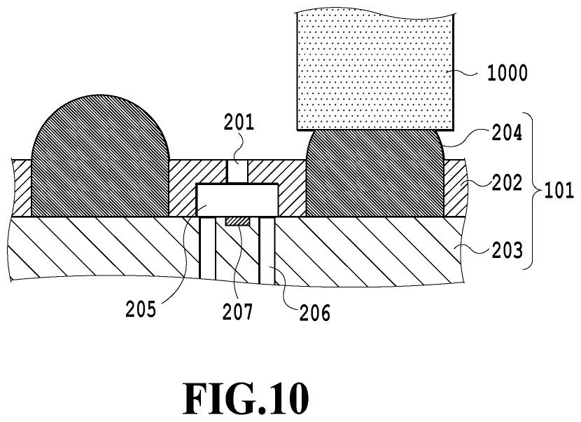

In S900, flat surfaces are formed in the third resin. FIG. 10 is an explanatory view of S900.

As shown in FIG. 10, in the present embodiment, after the protruding shapes of the third resin for forming the protrusions 204 are formed, leading ends of the third resin are scraped by using a scraper 1000 to form flat surfaces. By using a dispenser needle used in applying the third resin as the scraper 1000, the flat surfaces can be efficiently formed in the third resin. Note that as long as the flat surfaces can be formed in the third resin, an apparatus other than an apparatus used to apply the third resin may be used as the scraper 1000.

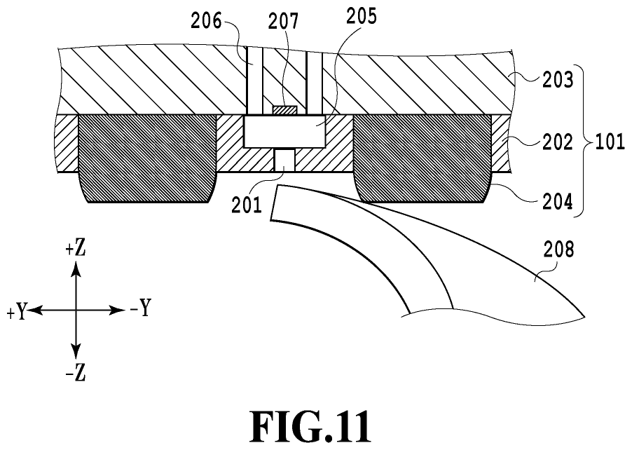

FIG. 11 is a schematic sectional view of the printing element board 101 which is applicable to the present embodiment.

As shown in FIG. 11, a cross-sectional shape of leading end portions which protrude in the protrusion 204 of the present embodiment more than the ejection port surface of the nozzle forming member 202 is a substantially trapezoidal shape. By forming the leading end portion of the protrusion 204 into a flat surface, an angle can be added to the leading end portion of the protrusion 204 such that the leading end portion bulges from the outside to the inside. With this, the printing medium 208 is less likely to come into contact with the nozzles 201 as compared with the first embodiment in which the leading end portion has a round shape even in the case where the protrusion amount of the leading end portion protruding from the ejection port surface is the same as that in the first embodiment.

Therefore, according to the liquid ejection head of the present embodiment, the protection capability for nozzles can be further improved.

### [Modification of Second Embodiment]

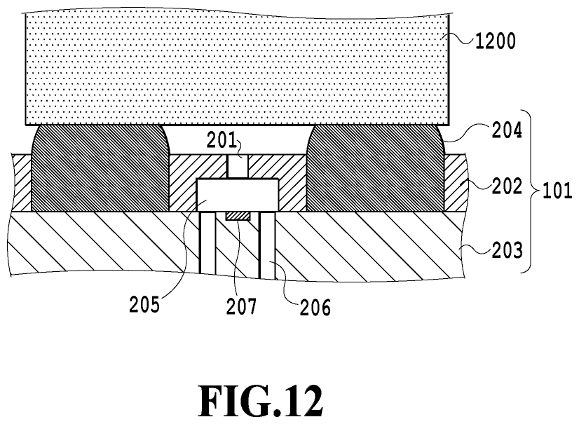

FIG. 12 is a diagram showing a modification of S900. In the example of FIG. 10, the flat surfaces are formed by scraping the leading end portions of the third resin with the scraper 1000 (see FIG. 10). However, the method for forming flat surfaces in the third resin is not limited to such a method.

As shown in FIG. 12, flat surfaces may be formed by pressing the third resin from leading ends toward base ends by using a pressing member 1200. The material constituting the pressing member 1200 contains fluororesin. Then, a liquid repellent treatment has been applied to the pressing surface of the pressing member 1200 which presses the third resin. According to this configuration, even in the case of pressing a third resin having a relatively high viscosity in order to form protruding shapes, the pressing member 1200 can be favorably removed from the third resin.

Note that in the example of FIG. 12, flat surfaces are formed in a plurality of pieces of the third resin by using one pressing member 1200. According to the method for forming a plurality of flat surfaces together in one process, the productivity is improved. However, a flat surface may be formed in one piece of the third resin by using one pressing member 1200. Flat surfaces can be formed in leading end portions of the third resin by such a method as well.

### Third Embodiment

An object of the present embodiment is to provide a liquid ejection head having higher reliability. In the following description, configurations that are the same as or correspond to those in the first and second embodiments are denoted by the same signs and description thereof is omitted, and different points will be mainly described.

In S503 (see FIG. 5) of the present embodiment, at least one side of the first planned portions 603 (see FIG. 6B) is masked by the first mask 602 (see FIG. 6B) in addition to the portions masked in the first embodiment.

In S506 (see FIG. 5) of the present embodiment, at least one side of the third planned portions 608 (see FIG. 6C) is masked by the second mask 607 (see FIG. 6C) in addition to the portions masked in the first embodiment.

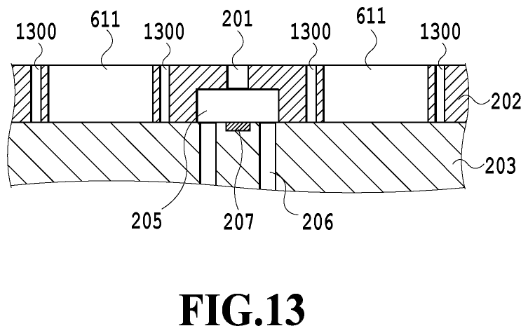

In S508 (see FIG. 5) of the present embodiment, grooves 1300 (see FIG. 13) are formed on at least one side of each of the holes 611. That is, in the present embodiment, the pressure chambers 205, the nozzles 201, the holes 611, and the grooves 1300 are simultaneously formed by the developing process of S508.

FIG. 13 is an explanatory view of S508 of the present embodiment.

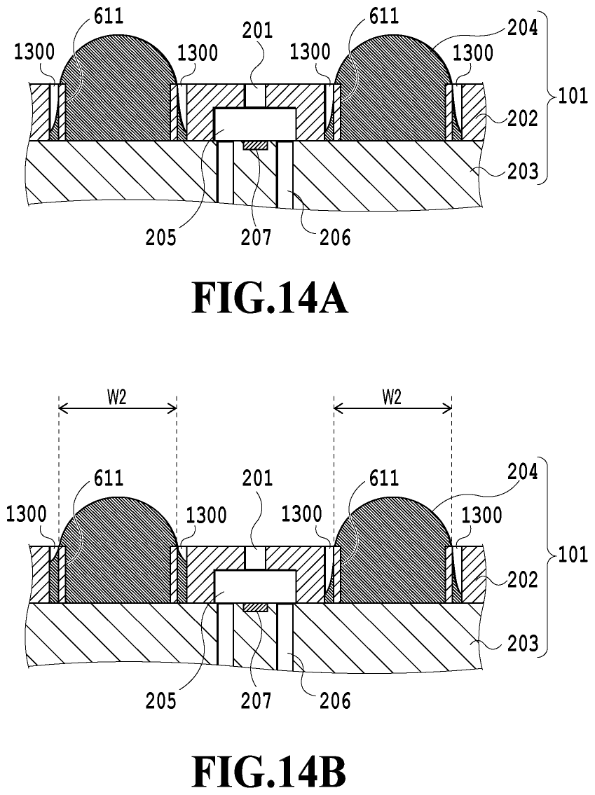

As shown in FIG. 13, the nozzle forming member 202 of the present embodiment includes the grooves 1300 which are formed on at least one side of each of the regions where the protrusions 204 (see FIGS. 14A and 14B) are buried.

FIG. 14A is an explanatory view of a step of applying the third resin in the present embodiment.

As shown in FIG. 14A, the grooves 1300 for allowing the third resin that has overflowed from the holes 611 to escape are formed on at least one sides of the regions where the protrusions 204 are buried in the present embodiment. Note that by forming the grooves 1300 on both sides of the holes 611 as in FIG. 14A, it is possible to increase the amount of the third resin that can be allowed to escape as compared with the configuration in which the grooves 1300 are formed only on one sides of the holes 611.

There is also a case where the third resin overflows from the holes 611 for some reason during the application of the third resin constituting the protrusions 204 to the holes 611. Even if the third resin has overflowed from the holes 611, since the grooves 1300 are formed on at least one sides of the holes 611, the third resin that has overflowed can be allowed to escape into the groove 1300.

FIG. 14B is an explanatory view of an effect of the grooves 1300.

As shown in FIG. 14B, there is also a case where the amount of the third resin overflowing is different among locations at which the holes 611 are formed. Even in such a case where the amount of the third resin overflowing is different among locations, as long as all the overflowing third resin can be allowed to escape into the grooves 1300, the width “W2” of the protrusions 204 becomes the same dimension at any location. That is, according to this configuration, even in a case where the amount of the third resin overflowing is different among locations, protrusions 204 having a constant width “W2” can be formed with high precision.

Therefore, according to the technique of the present embodiment, a liquid ejection head having higher reliability can be provided.

### Other Embodiments

The order of the steps shown in FIG. 5 may be switched as appropriate, and the steps shown in FIG. 5 may be conducted together. In the example of FIG. 5, S509 is conducted immediately after S508. However, in a case where the timing to conduct S509 is after S508, another step may be conducted between S508 and S509. In this way, the protrusions 204 (see FIG. 2 and the like) can be formed any time after the holes 611 (see FIG. 6 and the like) are formed.

It is preferable that a liquid repellent film have photosensitivity. However, in the case where the thickness of the liquid repellent film is sufficiently small like 1 μm or less, the liquid repellent film does not have to have photosensitivity. This is because in the case where the thickness of the liquid repellent film is 1 μm or less, the liquid repellent film can be removed in S508 (the step of developing process) of FIG. 5. In this way, the technique of the present disclosure can be applied to a liquid ejection head in which a liquid repellent film is formed on a nozzle surface.

Although a liquid repellent film is not formed on the upper surface of the second resin 606 in the example of FIG. 6C, a liquid repellent film may be formed on the upper surface of the second resin 606. Regardless of the presence or absence of a liquid repellent film, the protrusions 204 (see FIG. 2 and the like) can be formed; however, by forming a liquid repellent film on the ejection port surface of the nozzle forming member 202, the liquid repellency of the ejection port surface can be improved as compared with the case where there is no liquid repellent film.

In the above-described embodiments, the heater 207 (see FIG. 2 and the like) is used as a heating resistance element for generating energy to eject the ink. However, a piezoelectric element or another energy generating element may be used as the heating resistance element. The ink may be ejected by an ejection method using a piezoelectric element or another method.

In addition, although the nozzle forming member 202 is made of a resin in the above-described embodiments, the material constituting the nozzle forming member 202 may be a metal or an inorganic material.

In addition, although the holes 611 (see FIG. 6D and the like) are formed by the photolithography technique in the above-described embodiments, the holes 611 may be formed by laser, dry etching, or another method, or the like.

According to the technique of the present disclosure, a liquid ejection head having high reliability in which breakage of a nozzle is less likely to occur can be provided.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-098641, filed Jun. 19, 2024, which is hereby incorporated by reference herein in its entirety

What is claimed is:

1. A liquid ejection head comprising:
a nozzle forming member in which a nozzle configured to eject a liquid is formed;
a substrate being stacked on the nozzle forming member and including a flow passage for supplying the liquid to the nozzle; and
a protrusion protruding more than a surface of the nozzle forming member, and having a base end buried inside the nozzle forming member, in a direction perpendicular to the surface of the nozzle forming member.

2. The liquid ejection head according to claim 1, wherein
the protrusion is a thermosetting resin.

3. The liquid ejection head according to claim 1, wherein
an elastic modulus of the protrusion is 2 GPa or more.

4. The liquid ejection head according to claim 1, further comprising:
an electric connection portion configured to receive power for ejecting the liquid from the nozzle; and
a sealant configured to seal the electric connection portion, wherein
the protrusion and the sealant are formed of the same material.

5. The liquid ejection head according to claim 1, wherein
the protrusion extends in parallel with a nozzle array in which a plurality of the nozzles are arranged in a first direction in a state where the liquid ejection head is viewed in a direction of ejection.

6. The liquid ejection head according to claim 1, wherein
one of the nozzle is sandwiched by two of the protrusions in a state where the liquid ejection head is viewed in a direction of ejection.

7. The liquid ejection head according to claim 1, wherein
the protrusion is arranged in a form of a dashed line extending in parallel with a nozzle array in which a plurality of the nozzles are arranged in a first direction in a state where the liquid ejection head is viewed in a direction of ejection.

8. The liquid ejection head according to claim 1, wherein
the protrusion is a dot, and a plurality of the protrusions are formed along a nozzle array in which a plurality of the nozzles are arranged in a first direction in a state where the liquid ejection head is viewed in a direction of ejection.

9. The liquid ejection head according to claim 1, wherein
the protrusion includes a region formed in parallel with a nozzle array in which a plurality of the nozzles are arranged in a first direction, and a region extending in a second direction intersecting the first direction in a plane outward of the nozzle array in the first direction, in a state where the liquid ejection head is viewed in a direction of ejection.

10. The liquid ejection head according to claim 1, wherein
the protrusion is surrounding the nozzle in a state where the liquid ejection head is viewed in a direction of ejection.

11. The liquid ejection head according to claim 1, wherein
a cross-sectional shape of a region which protrudes more than the nozzle forming member in the protrusion is a substantially trapezoidal shape.

12. The liquid ejection head according to claim 1, wherein
in the nozzle forming member, a groove is formed on at least one side of a region in which the protrusion is buried.

13. The liquid ejection head according to claim 1, wherein
the substrate includes an element configured to generate energy for ejecting the liquid from the nozzle.

14. The liquid ejection head according to claim 1, wherein
a distance from an end portion of the nozzle to the protrusion in a direction perpendicular to the surface of the nozzle forming member is more than 20 μm and less than 60 μm.

15. The liquid ejection head according to claim 1, wherein
a height of the protrusion from the surface of the nozzle forming member in a direction parallel with the surface of the nozzle forming member is more than 20 μm and less than 500 μm.

16. A liquid ejection head comprising:
a nozzle forming member in which a nozzle configured to eject a liquid is formed;
a substrate being stacked on the nozzle forming member and including a flow passage for supplying the liquid to the nozzle; and
a protrusion protruding more than a surface of the nozzle forming member, and having a base end in contact with the substrate in a direction perpendicular to the surface of the nozzle forming member.

17. The liquid ejection head according to claim 16, wherein
a depth by which the protrusion is buried in the nozzle forming member is equal to a length of the nozzle.

18. A method for manufacturing a liquid ejection head including: a nozzle forming member in which a nozzle configured to eject a liquid is formed; a substrate being stacked on the nozzle forming member and including a flow passage for supplying the liquid to the nozzle; and a protrusion protruding more than a surface of the nozzle forming member in a direction perpendicular to the surface of the nozzle forming member, the method comprising the steps of:
forming the nozzle and a hole in the nozzle forming member;
forming the protrusion by applying a curable resin to the hole; and
curing the protrusion.

19. The method for manufacturing a liquid ejection head according to claim 18, wherein
in the step of forming the hole in the nozzle forming member, the hole is formed by a photolithography technique.

20. The method for manufacturing a liquid ejection head according to claim 18, wherein
in the step of forming the hole in the nozzle forming member, the hole is formed simultaneously with the nozzle.
